(19) United States
(12) Patent Application Publication
(10) Pub. No.: US 2018/0285312 A1
(43) Pub. Date: Oct. 4, 2018

(54) METHODS, SYSTEMS, AND MEDIA FOR PROVIDING CONTENT BASED ON A LEVEL OF CONVERSATION AND SHARED INTERESTS DURING A SOCIAL EVENT

(71) Applicant: Google Inc., Mountain View, CA (US)

(72) Inventors: Eric H. Liu, Santa Clara, CA (US); Alok Chandel, Sunnyvale, CA (US); Justin Koh, Mountain View, CA (US); Pierre-Yves Laligand, Mountain View, CA (US)

(21) Appl. No.: 14/196,837

(22) Filed: Mar. 4, 2014

(51) Int. Cl. G06F 15/173

(52) U.S. Cl. CPC G06F 15/173

(57) ABSTRACT

Methods, systems, and media for providing content based on shared interests during a social event are provided. In some implementations, the method comprises: determining, using a hardware processor, that a social event is in progress; receiving identifying information of one or more users attending the social event; identifying the one or more users attending the social event based on the identifying information; causing publicly available information about one or more interests of the identified one or more users to be retrieved; extracting interests common to at least two of the identified one or more users from the retrieved publicly available information; and causing content to be presented based on the extracted interests.

### TECHNICAL FIELD

The disclosed subject matter relates to methods, systems, and media for providing content based on a level of conversation and shared interests during a social event.

### BACKGROUND

Attendees of a social event often find initiating conversations difficult, even though they may have shared interests. However, once these attendees at the social event begin having an organic conversation, it may lead to additional conversation about other topics and/or interests of the user. One approach that has been proposed for dealing with the initial difficulty of starting a conversation at a social event is to conduct icebreaker-type games where attendees are required to share some information about themselves. However, such icebreakers often fail to initiate organic conversations due to lack of coordination and awkwardness that may result from such forced participation.

Accordingly, it is desirable to provide methods, systems, and media for providing content based on a level of conversation and shared interests during a social event.

### SUMMARY

In accordance with various implementations of the disclosed subject matter, methods, systems, and media for providing content based on a level of conversation and shared interests during a social event are provided.

In accordance with some implementations, a method for providing content based on shared interests during a social event is provided, the method comprising: determining that a social event is in progress; receiving identifying information of one or more users attending the social event; identifying the one or more users attending the social event based on the identifying information; causing publicly available information about one or more interests of the identified one or more users to be retrieved; extracting interests common to at least two of the identified one or more users from the retrieved publicly available information; and causing content to be presented based on the extracted interests.

In accordance with some implementations, a system for providing content based on shared interests during a social event is provided, the system comprising: a hardware processor programmed to: determine that a social event is in progress; receive identifying information of one or more users attending the social event; identify the one or more users attending the social event based on the identifying information; cause publicly available information about one or more interests of the identified one or more users to be retrieved; extract interests common to at least two of the identified one or more users from the retrieved publicly available information; and cause content to be presented based on the extracted interests.

In accordance with some implementations, a non-transitory computer-readable medium containing computer executable instructions that, when executed by a processor, cause the processor to perform a method for providing content based on shared interests during a social event, the method comprising: determining that a social event is in progress; receiving identifying information of one or more users attending the social event; identifying the one or more users attending the social event based on the identifying information; causing publicly available information about one or more interests of the identified one or more users to be retrieved; extracting interests common to at least two of the identified one or more users from the retrieved publicly available information; and causing content to be presented based on the extracted interests.

In accordance with some implementations, a system for providing content based on shared interests during a social event is provided, the system comprising: means for determining that a social event is in progress; means for receiving identifying information of one or more users attending the social event; means for identifying the one or more users attending the social event based on the identifying information; means for causing publicly available information about one or more interests of the identified one or more users to be retrieved; means for extracting interests common to at least two of the identified one or more users from the retrieved publicly available information; and means for causing content to be presented based on the extracted interests.

In some implementations, the identifying information includes image data of the one or more users' facial features, and the means for identifying the one or more users attending the social event comprises means for using facial recognition techniques on the image data.

In some implementations, the identifying information includes information identifying a user device associated with each of the one or more users attending the social event.

In some implementations, the publicly available information is retrieved from a social networking service with which at least one of the one or more users maintains a social networking profile associated with information indicative of the user's interests.

In some implementations, the system further comprises: means for receiving audio data captured during the social event; means for determining a level of conversation based on the audio data; and the means for causing content to be presented based on the extracted interests comprises means for determining an amount of content to presented based on the level of conversation.

In some implementations, the amount of content to be presented is increased upon determining that the level of conversation is below a threshold.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a process for determining a topic of conversation based on abstracted audio information in accordance with some implementations of the disclosed subject matter.

FIG. 2 shows an illustrative example of a process for calculating updated scores and ranking topics by score in accordance with some implementations of the disclosed subject matter.

FIG. 3 shows an example of a diagram illustrating a relationship between keywords and topics in accordance with some implementations of the disclosed subject matter.

FIG. 4 shows an example of a table illustrating one technique for storing points and associated topics in accordance with some implementations of the disclosed subject matter.

FIGS. 5A-5D show diagrams illustrating an example of a process for displaying information related to a topic of conversation in accordance with some implementations of the disclosed subject matter.

FIG. 6 shows a schematic diagram of an illustrative system suitable for implementation of an application for determining a topic of conversation based on abstracted audio information in accordance with some implementations.

FIG. 7 shows a detailed example of the server and one of the content display devices of FIG. 6 that can be used in accordance with some implementations of the disclosed subject matter.

FIG. 8 shows a diagram illustrating an example of a data flow that can be used in processes of FIGS. 1, 2 and 5A to 5D in accordance with some implementations of the disclosed subject matter.

FIG. 9 shows a diagram illustrating another example of a data flow that can be used in processes of FIGS. 1, 2 and 5A to 5D in accordance with some implementations of the disclosed subject matter.

FIG. 10 shows an example of a process for presenting content based on a level of conversation and shared interests during a social event in accordance with some implementations of the disclosed subject matter.

FIG. 11 shows an example of a group of users attending a social gathering while the mechanisms described herein cause content to be displayed in accordance with some implementations of the disclosed subject matter.

FIG. 12 shows a diagram illustrating an example of a data flow that can be used in the process of FIG. 10 among a computing device, one or more social media servers, and one or more content delivery servers in accordance with some implementations of the disclosed subject matter.

FIG. 13 shows a diagram illustrating another example of a data flow that can be used in the process of FIG. 10 among a computing device, one or more social media servers, and one or more content delivery servers in accordance with some implementations of the disclosed subject matter.

### DETAILED DESCRIPTION

In accordance with various implementations, mechanisms for determining a topic of conversation based on abstracted audio information are provided. Generally speaking, a topic of conversation can be determined while maintaining user privacy by abstracting the audio used for determining the topic of conversation, and by not storing the original audio and/or text used to determine the topic of conversation. In some implementations, these mechanisms can receive audio data using an audio input device, such as a microphone. This audio data can represent speech by one or more users in at least one location. For example, a computing device, such as a set-top box, can capture audio from a conversation taking place between two users in a room where the set-top box is located.

It should be noted that, prior to receiving audio data using an audio input device, these mechanisms will provide the user with an opportunity to provide a consent or authorization to perform actions, such as activating an audio input device and transmitting audio data. For example, upon loading an application on a computing device, such as a television device, the application can prompt the user to provide authorization for activating an audio input device, transmitting audio data, determining a topic of conversation, and/or presenting content. In a more particular example, in response to downloading the application and loading the application on the computing device, the user can be prompted with a message that requests (or requires) that the user provide consent prior to performing these actions. Additionally or alternatively, in response to installing the application, the user can be prompted with a permission message that requests (or requires) that the user provide content prior to performing these detections and/or transmitting information relating to these detections. In the instance where the user consents to the use of such data, audio data from an audio input device can be received and a topic of conversation can be determined.

In some implementations, audio data that is received can be converted to text data. For example, a classification model can be used to convert audio data received from a microphone at a location into text data. Such text data can be in the form of words and/or phrases recognized by the classification model. In one particular example, a Hidden Markov Model can be trained to recognize words and/or phrases from audio data. In an example where a conversation is taking place between two users in a room, the audio data of the two users can be converted to text as the conversation is ongoing to allow for the topic of the conversation to be determined while the conversation is taking place. Additionally, after the audio data is converted to text, the audio data used as the basis for the text conversion can be overwritten, deleted and/or otherwise discarded to maintain the privacy of users by not storing the audio data for an extended period of time. For example, the audio data can be deleted as text is extracted from the audio data. In another example, the audio data can be deleted on a rolling basis, with only the most recent audio data retained for conversion to text. In a more particular example, a circular buffer can be used to temporarily record audio data corresponding to a predetermined amount of audio data (e.g., one second, two seconds, five seconds, etc.) and the oldest audio data can be continually overwritten with newly recorded audio data.

In some implementations, the words and/or phrases from the text can be compared to keywords or phrases that are each associated with one or more topics. For example, a set of words can be defined that are associated with each of various topics, such as Sports, Travel, Finance, etc. It should be noted that, in some implementations, a content database and/or a knowledgebase can be queried to determine topics that may be associated with each keyword and/or phrase. Words and/or phrases from the text can be compared to the keywords or phrases associated with the various topics. Additionally, as the text data is compared to the keywords and/or phrases the text data can be deleted or discarded to maintain the privacy of the user. For example, the text can be deleted as words from the text are used to determine keywords and/or phrases. As another example, text can be deleted on a rolling basis, with only the most recent text retained for use in determining keywords and/or phrases. In a more particular example, a circular buffer can be used to temporarily record text data corresponding to a predetermined amount of text information (e.g., the last fifty words, the last two hundred characters, text generated based on the last ten seconds of audio data, etc.).

In some implementations, points can be generated and associated with a topic when a word or phrase from the text matches a keyword or phrase associated with the topic. For example, in the case where two users are having a conversation, one user may begin telling the other user about a football game that took place the night before. As the users talk about football, the audio of their conversation can be converted to text and the words and phrases of the text compared to keywords and phrases. In the users' discussion about the football game the night before the users may utter words that are typically associated with sports, such as “yards,” “football,” “touchdown,” etc. If these words are converted to text and match a keyword or phrase, then a point can be generated and associated with the topic Sports. After these points are generated, they can be disconnected from the words that were used to generate them. For example, after a point has been generated, it is no longer associated with a word or phrase uttered by a user, but is instead only associated with one or more topics. This can allow for a topic of conversation to be determined without a risk that the conversation between users is being recorded. This can assuage privacy concerns that users may have concerning a device recording their conversations, which can otherwise result in a user not using a device that responds to ambient conversation. Additionally, after points are generated, keywords and/or phrases used to generate the points can be deleted to maintain the privacy of the user. For example, keywords and/or phrases can be deleted as points are generate based on the keywords and/or phrases. As another example, keywords and/or phrases can be deleted on a rolling basis, with only the most recent keywords and/or phrases retained for use in determining keywords and/or phrases. In a more particular example, a circular buffer can be used to temporarily record keyword data corresponding to a predetermined amount of keyword data (e.g., the last keyword, the last five keywords, keywords corresponding to text generated from the last ten seconds of audio data, etc.).

In some implementations, a topic of conversation having a high score from among the various topics can be selected. For example, if the topic with the highest score is Food, then that topic can be selected as the current topic of conversation. As another example, more than one topic can be selected as a current topic that is relevant to a topic of conversation. Additionally or alternatively, a set number of the highest scoring topics (e.g., two, three, etc.) can be selected as relevant to the current conversation. More particularly, if the score for a topic is over a predetermined threshold score, the topic can be selected as a relevant topic. Such a threshold can be a particular number of points (e.g., twenty points, thirty points, etc.) or can be dynamically adjusted (e.g., a percentage—such as, fifty percent, eighty percent, etc.—of the score of the highest scoring topic).

In some implementations, these mechanisms can update the score(s) associated with topics as new keywords are generated based on audio received related to an ongoing conversation. Additionally, the scores can be recalculated on an ongoing basis (e.g., as keywords are generated and matched to topics) and/or periodically (e.g., scores can be updated every minute, every five minutes, etc.). In some implementations, topics can be ranked based on the topic scores and can be re-ranked periodically based on updated scores, and one or more relevant topics can be selected based on the ranking and/or updated ranking. It should be noted that points can be set to expire after a predetermined period of time and/or can be subject to a decay parameter such that the scores are likely to reflect topics that have been discussed more recently and/or are currently being discussed.

In some implementations, a topic of conversation determined using the mechanisms described herein can be used to present content to a user. The content can be presented as part of a slideshow that plays when a display is not being used for another purpose (e.g., as a screensaver application). The content presented can be related to the topic of conversation. For example, if the topic of conversation is determined to be “Sports” because the audio data contains words related to football, content related to football and/or other sports-related content can be presented to the user. This can facilitate conversation by presenting users with content that may spur the conversation onto another topic related to the content presented to the user.

The mechanisms described herein can be used in various applications. For example, a selected topic of conversation can be used to provide content to a user that is relevant to a current conversation. As another example, a selected topic of conversation can be used to make recommendations (e.g., movies, restaurants, etc.) to a user based on the current topic of conversation. As yet another example, a selected topic of conversation can be recorded to keep a record of the general topic of conversation without compromising a user's privacy by recording the actual contents of the conversation.

In one particular example, two users can be having a conversation about a football game that happened the night before. The topic of conversation can be determined to be sports and content related to sports can be presented to the users. For example, content related to an upcoming football game and statistics about the teams (e.g., record, rankings, etc.) playing in the game can be presented to the users. An article about an upcoming basketball draft can then be presented to the users after the content related to the upcoming football game has been displayed for a predetermined amount of time. This can, for example, cause the users to start talking about basketball.

Continuing the above example, the users may begin talking about a restaurant to visit for lunch. As the users talk about lunch, the mechanism can change the topic of conversation food and content related to food and restaurants can be presented to the users. For example, images of food, recipe ideas, advertisements for restaurants (which can include coupons and/or deals), etc. can be presented to the user. If the user sees something that interests him or her, such as an image of food or a restaurant advertisement, the user can indicate that he or she is interested in that particular content by, for example, pressing a button on a remote control or any other suitable user input interface.

In another example, two users are having a conversation about action movies and content related to action movies can be presented to the user. Such content can include advertisements for movies that are available to watch using a service to which the user subscribes (e.g., video-on-demand, over-the-top content, etc.). For example, the movies can be available for streaming from an online movie streaming service or available as video-on-demand content from a cable television service.

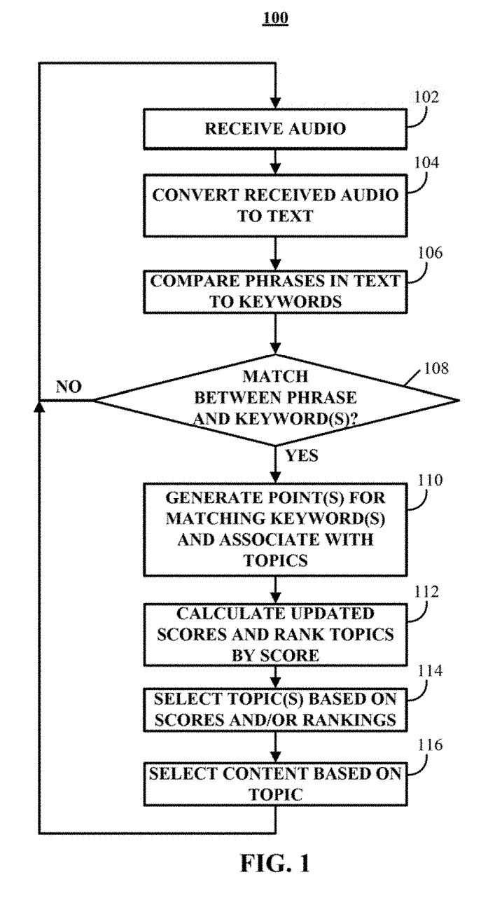

Turning to FIG. 1, an example 100 of a process for determining a topic of conversation is shown in accordance with some implementations. At 102, a topic determination application can receive audio data corresponding to speech by a user. In some implementations, the topic determination application can be launched by a user (e.g., a user can cause the topic determination application to be launched by a computing device). Additionally or alternatively, the topic determination application can execute as a background application that automatically detects that a conversation is ongoing (e.g., by detecting one or more users in proximity to the computing device executing the topic determination application, by detecting audio over a threshold loudness, etc.) and runs when a conversation is detected. In some implementations, a user can control whether to execute the topic determination application as a background application or as an application that must be launched by the user. In some implementations, the topic determination application can detect audio using any suitable techniques, such as by receiving audio from a microphone, receiving audio from a computing device that captured the audio using a microphone, etc.

It should be noted that, prior to receiving audio data corresponding to speech by a user, the topic determination application will provide the user with an opportunity to provide a consent or authorization to perform such actions. For example, upon loading the topic determination application on a computing device, such as a television device, the application can prompt the user to provide authorization for transmitting audio data, detecting that a conversation is occurring, determining a topic of conversation, and/or presenting content related to the determined topic of conversation. In a more particular example, in response to downloading the topic determination application from a suitable marketplace and loading the topic determination application, the user can be prompted with a message that requests (or requires) that the user provide consent prior to transmitting audio data. Additionally or alternatively, in response to installing the topic determination application, the user can be prompted with a permission message that requests (or requires) that the user provide content prior to transmitting audio data. In the instance where the user consents to the use of such data, audio data can be received at 102.

In some implementations, the audio data can be received from a microphone that captures audio at a specific location. For example, the microphone can be placed in a room and the audio data can represent audio that is audible at the location of the microphone. In some implementations, the audio data can be received from multiple microphones that are not collocated. For example, the audio data can represent audio being transmitted on a telephone call, a conference call, a video call, etc. More generally, the audio data can be received from any suitable source.

At 104, the topic determination application can convert the audio data to text that is representative of speech contained in the audio data. Any suitable technique can be used to convert the audio data to text. For example, a Hidden Markov Model (HMM) based technique for speech recognition can be used to convert the contents of the audio data to text. In another example, a dynamic time warping (DTW) based technique for speech recognition can be used to convert the contents of the audio data to text.

In some implementations, the text produced from the converted audio data can be organized as individual words. Additionally or alternatively, the text can be organized as phrases using any suitable technique. For example, a classification model can be trained to identify consecutive words that are likely to belong to a single phrase. In one particular example, the words “los” and “angeles” can be identified as likely being part of the single phrase “Los Angeles.” Additionally, in some implementations, certain words that correspond to parts of speech unlikely to correspond to any specific topic can be discarded or ignored when converting the audio to text. For example, pronouns, definite and indefinite articles, conjunctions, and any other words that do not specifically identify the subject that is being discussed can be that ignored and/or discarded from the text produced.

In some implementations, certain words and/or phrases can be included on a list of words and/or keywords to ignore when converting audio to text. For example, words that may be associated with certain topics such as sex, violence, gambling, or other topics that some users may find to be sensitive topics can be included on a list of keywords to ignore. These words and/or topics can be presented to the user in a setup interface or the like, and the user can choose whether to include or exclude the topics. In some implementations, the user can be presented with a list of topics and choices as to whether to include or exclude the topics. Additionally or alternatively, the user can be presented with a list of particular words that some users may find sensitive for various reasons and choices as to whether to include or exclude the words.

In some implementations, the user can be presented with various settings as a list and/or a slider user interface element. For example, the user can be presented with privacy settings and/or parental control settings as a list and/or slider user interface element. The user can then set the privacy settings and/or parental control settings at a suitable level and the topic determination application can automatically add words to a list of words to ignore based on the settings. For example, if the user sets privacy settings to a high level, the topic determination application can add words that are more specific to a list of words to ignore (e.g., proper nouns, specific numbers, etc.) and can operate using more general words. Continuing the example, if the user sets privacy settings to some intermediate level, the topic determination application can use words that are specific, but not track user preferences or the like and can ignore names such as user names. As another example, if the user sets parental control settings to a high level, the topic determination application can add words that correspond to topics such as sex, violence, gambling, etc., to a list of ignored words and or a list of excluded topics that will not be used to generate select content.

In some implementations, the topic determination application can cause the audio to be converted to text by another application. For example, an application programming interface that converts audio to text can be utilized to perform the actions required to convert audio to text.

At 106, the topic determination application can compare the words and/or phrases of the text to a set of keywords and/or phrases, which are collectively referred to herein as keywords. In some implementations, the keywords can be stored in a database and any suitable technique can be used to compare words and/or phrases from the text to keywords in the database. For example, for each word or phrase in the text, a database query can be performed to determine whether the database contains a keyword that matches the word or phrase from the text. In some implementations, the set of keywords to be used can be obtained and/or generated using any suitable techniques. For example, topics can first be specified using any suitable techniques, and a knowledgebase or the like can be used to generate keywords related to each topic. As another example, keywords can be generated based on popular search terms used by users of a search engine or the like. As yet another example, a developer or other person can curate a list of keywords for the topic determination application to use. As still another example, a combination of such techniques can be used for generating the keywords to be used.

At 108, the topic determination application can determine whether there is a match between a word or phrase in the text and a keyword. In some implementations, words or phrases from the text that are similar to a keyword but contain some small differences can be counted as a match. For example, if two keywords are homonyms or homophones of one another, both keywords can be considered a match to a word or phrase in the text. As another example, if two words are difficult to distinguish using audio to text techniques, either word can be counted as a match to a keyword that matches one of the two words.

If there is a match between a word or phrase in the text and a keyword (“YES” at 108), the topic determination application can move to 110. Otherwise, if it is determined that a match has not been found (“NO” at 108), the topic determination application can return to 102. In some implementations, if it is determined that a match has not been found, the topic determination application can determine whether a predetermined amount of time (e.g., thirty seconds, one minute, etc.) has passed since topic scores were last updated. For example, if no matches are found for one minute, the topic determination application can move to 112 and calculate updated scores as described below in connection with 112.

At 110, the topic determination application can generate a point (or points) corresponding to the matching keyword and associate the generated point with topics associated with the matching keyword. In some implementations, each keyword can be associated with one or more topics that the keyword is relevant to. These topics can include broad topics such as: Finance, Sports, Fashion, Food, Travel, Technology, Science, Art, Entertainment, etc. Additionally or alternatively, the topics can include more specific sub-topics. For example, Sports can include sub-topics for football, baseball, basketball, etc. As another example, entertainment can include sub-topics for movies, theater, television, music, etc.

Topics and/or subtopics to be used can be generated using any suitable techniques. For example, in some implementations, topics and/or subtopics can be generated from a knowledgebase or the like. As another example, topics and/or subtopics can be generated based on search terms used by users of a search engine or the like. As yet another example, a developer or other person can curate a list of topics and/or subtopics for the topic determination application to use. As still another example, a combination of such techniques can be used for generating the topics and/or subtopics to be used.

In some implementations, a user can choose a privacy setting that can be used to determine a granularity of the topics used by the topic determination application. For example, a user can adjust a privacy setting to allow the topic determination application to use sub-topics as described above. In such an example, if users are talking about Chinese food, the topic determination application can determine that the topic of conversation is Chinese food rather than identifying the topic of conversation as Food.

As yet another example, the user can adjust a privacy setting to allow the topic determination application to use names spoken by a user to search for and/or find a more specific topic of conversation. In such an example, rather than identifying the topic of conversation as Sports, the topic determination application can determine that the topic of conversation is a particular football team from San Francisco.

It should be noted that in implementations described herein in which the topic determination application (or other mechanisms described herein) collects information about a particular user, the user will be provided with an opportunity to control whether the topic determination application (or other mechanisms) collects information about particular users and/or how collected user information is used by the topic determination application (or other mechanisms). Examples of information about a user can include the user's interests, a user's location, names spoken by the user, etc. Additionally, certain information about the user can be stored locally (e.g., not shared), encrypted, and/or treated in one or more ways before it is stored to remove personal information. For example, a user's identity can be treated such that no personal information can be determined for the user. As another example, a user's geographic location can be generalized where location information is obtained (e.g., to a city level, a ZIP code level, a state level, etc.), so that a particular location of a user cannot be determined. Using these techniques and others described herein, the user can have control over what information is collected about the user and/or how that information is used by the topic determination application (or other mechanisms).

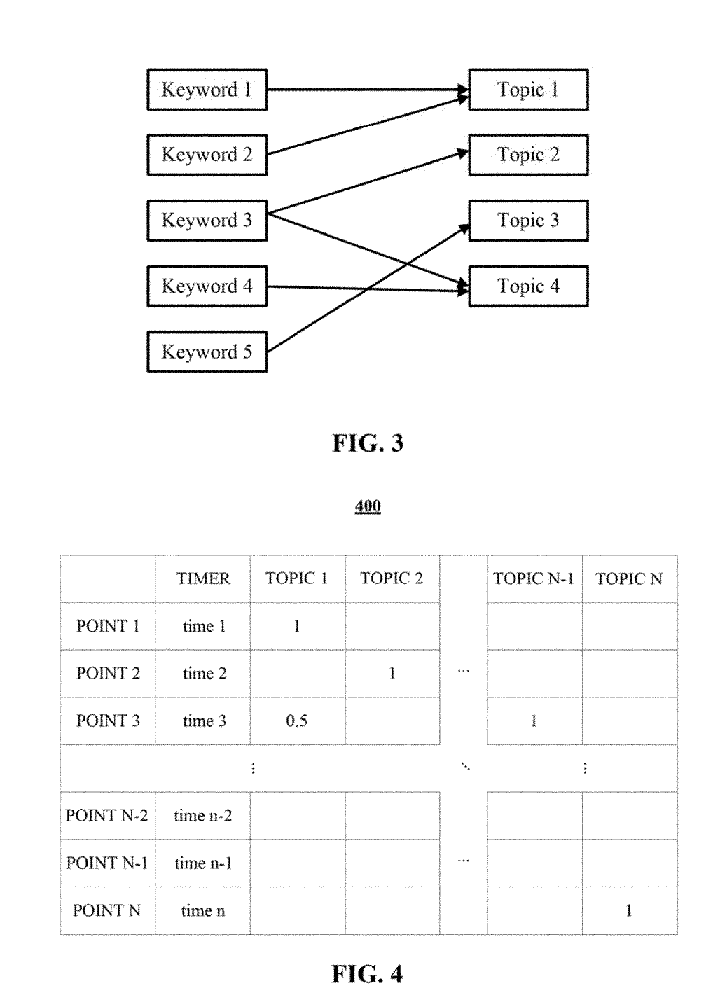

In some implementations, where keywords are stored in a database, each entry for a keyword can contain a reference to a topic and/or sub-topics associated with the keyword. In such implementations, the topic determination application can determine which topics are associated with the keyword and generate a point associated with each of the topics associated with the keyword. FIG. 3 shows an example of a relationship between keywords and topics. As shown in FIG. 3, each keyword can be associated with one or more topics. In the example of FIG. 3, keyword 1 is associated with topic 1, keyword 2 is also associated with topic 1, keyword 3 is associated with both topic 2 and topic m, and so on. Any suitable technique can be used to associate keywords with topics relevant to the keywords. In some implementations, a value of the points generated for each keyword can vary by topic according to the relevance of the word to a particular topic. For example, the phrase “Spanish Rice” can be considered relevant to both the food and travel topics. However, it can be considered more relevant to the food topic than the travel topic and have a correspondingly higher score associated with the food topic than the travel topic.

In some implementations, additional sensors can be used to gather additional data regarding a conversation and/or can be used to provide weight to topics. For example, a camera can be used to capture images and/or video of one or more users that are participating in a conversation. The images and/or video captured can be used to add weight to topics. For example, if the topic determination application determines from the images and/or video that a user is gesticulating, words that are spoken by the user can be given more weight if they are determined to match a keyword, as the user may be more excited about the words being spoken at that time. Additionally or alternatively, if the topic determination application determines from the audio that the pitch and/or volume of the received audio has changed in a particular fashion (e.g., the user's voice shifted to a higher frequency and/or the user's voice became louder), words that are spoken by the user can be given more weight if they are determined to match a keyword, as the user may be more excited about the words being spoken at that time.

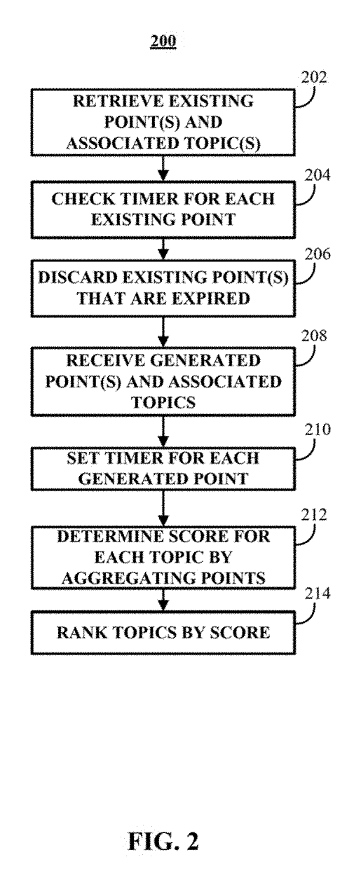

Referring back to FIG. 1, at 112 the topic determination application can calculate an updated score (or scores) for topics based on the point(s) generated at 110 and rank topics by score. In some implementations, as points are generated for a topic they can be added to a total score for that topic. FIG. 2 shows an example 200 of a process for calculating an updated score(s) and ranking topics based on the updated score(s). At 202, the topic determination application can retrieve existing points and topics associated with the existing points. In some implementations, the existing points can be kept in a database (or table) that identifies the point, when the point was generated and any topics associated with the point. Existing points can be retrieved at 202 from, for example, memory of a device executing the topic determination application.

As described above, one or more topics can be associated with each point based on the relevance of the keyword matched at 108 that caused the point to be generated. Each point can also have a timer associated with the point that indicates a time when the point was generated. In some implementations, the timer can count down from a predetermined number that is set when the point is generated, while in other implementations, the timer can be a time stamp that indicates a time when the point was generated.

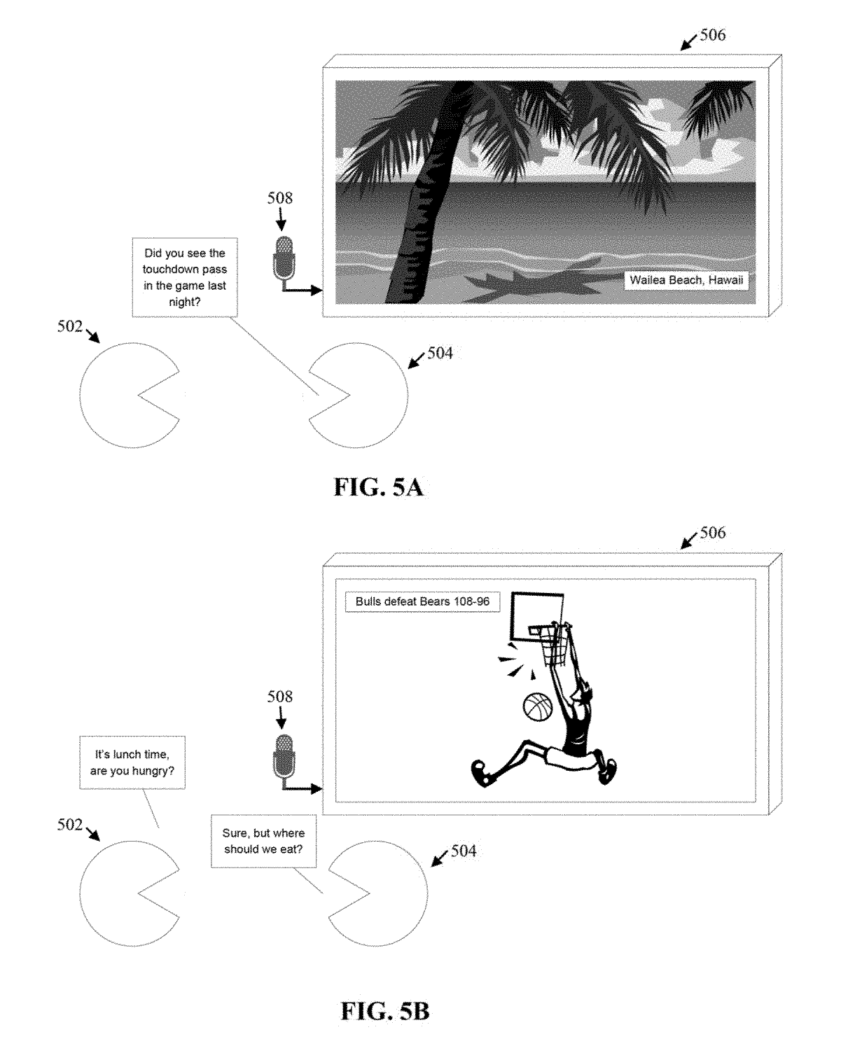

FIG. 4 shows an example 400 of a table containing information relating to points and topics associated with such points. In the example of FIG. 4, each point can be represented by a row in table 400 and can include an associated time representing timer information. Each row can contain entries that correspond to each topic and represent whether the point is associated with that topic. Further, an indication of whether the point for a particular row is associated with a particular topic can be in the form of a multiplier that indicates the relevance of the point to each topic. For example, POINT 3 in table 400 is associated with both TOPIC 1 and TOPIC N−1, but the multiplier for TOPIC 1 is one half whereas the multiplier for TOPIC N−1 is equal to one. A lower multiplier can indicate that the keyword that caused that particular point to be generated was relevant to a topic, but that it was not the most relevant topic for the particular keyword.

Returning back to FIG. 2, at 204, the topic determination application can check a timer associated with each existing point to determine if each point has expired. As described above, the timer can be a counter that counts down (or up) from a specified number, or a time stamp that indicates when the point was generated. The topic determination application can determine for each point whether that point has expired by checking the timer associated with that point. If the timer is a counter that counts down, the topic determination application can determine if the counter has reached zero (or any other suitable value). Alternatively, if the timer is a timestamp, the topic determination application can determine if a predetermined amount of time has elapsed since the point was generated. In some implementations, the topic determination application can add a decay parameter to points such that the value of points decreases as the time since the point was generated increases.

At 206, the topic determination application can discard any existing points that have expired. In some implementations, discarding the points can include deleting an entry in the database (or table) containing the points.

At 208, the topic determination application can receive a point(s) generated at 110 and an indication of topics associated with the point and set a timer for each generated point at 210. The generated point, associate topics and timer information can be added to the database (or table) of existing points. For example, a new entry in the database can be created for each generated point.

At 212, the topic determination application can determine a score for each topic based on the individual points in the database. In some implementations, the score can be determined by adding a contribution of each point associated with a particular topic. For instance, a score can be generated for a first topic by checking each point to determine if the first topic is associated with that point. In some implementations, as described above, a point can be associated with a particular topic with a multiplier that represents the relevance of the point to that topic. The process for generating a score for a topic can be repeated for each topic and the scores can be stored in memory in association with each topic.

At 214, the topic determination application can rank the topics by score from highest to lowest. This rank can represent a determination of a relevance of each topic to the audio data received at 102, where the highest ranked topic is determined to be the most relevant and the lowest ranked topic is determined to be the least relevant.

Referring back to FIG. 1, at 114 the topic determination application can select a topic or topics based on the rankings and/or scores calculated at 112. In some implementations, the topic determination application can select a highest ranked topic. Additionally or alternatively, the topic determination application can select any topic that has a score above a threshold. The topic(s) selected at 114 can be provided to a content display application for displaying content, such as a slideshow of images, to a user. The content display application can utilize the topics select by the topic determination application at 114 to determine content to display.

In some implementations, the topic determination application can cause the topic(s) selected at 114 to be associated with an account of a particular user. For example, if the content determination application is being executed by a user device, such as a smart television or a digital media receiver, and a particular user account is signed in on the device, the topic selected at 114 can be associated with the signed in user account, such that other devices associated with the user account can provide content based on the topic selected at 114. It should be noted that, in some implementations, a user can be required to affirmatively elect to receive content on other devices associated with the user account based on the topics selected by the topic determination application.

In some implementations, topics that are selected at 114 can be transmitted to a server and can be used to determine topics being discussed by users of the topic determination application. For example, when a topic is selected at 114, the topic determination application can cause the topic (e.g., Sports, Food, Politics, etc.) and a generalized location of the user (e.g., a zip code level, a city level, a state level, etc.) to be transmitted to a server. In another example, when a topic is selected at 114, the topic determination application can aggregate the topic with other selected topics for a generalized location (e.g., a zip code level, a city level, a state level, etc.) to be transmitted to a server. In such examples, infographics, graphs, charts, statistics, etc., can be generated based on the information provided from the users. It should be noted that, in some implementations, a user can be required to affirmatively elect to share the generalized information about selected topics and the user's general location to enable the topic determination application to share such information.

As described herein, the user will be provided with an opportunity to control whether the topic determination application collects information about particular users and/or how collected user information is used by the topic determination application. For example, a user's geographic location can be generalized where location information is obtained (e.g., to a city level, a ZIP code level, a state level, etc.), so that a particular location of a user cannot be determined. Using these techniques and others described herein, the user can have control over what information is collected about the user and/or how that information is used by the topic determination application.

At 116, the content display application can select content related to relevant topics to be displayed to a user based on the rankings and/or scores of topics select by the topic determination application.

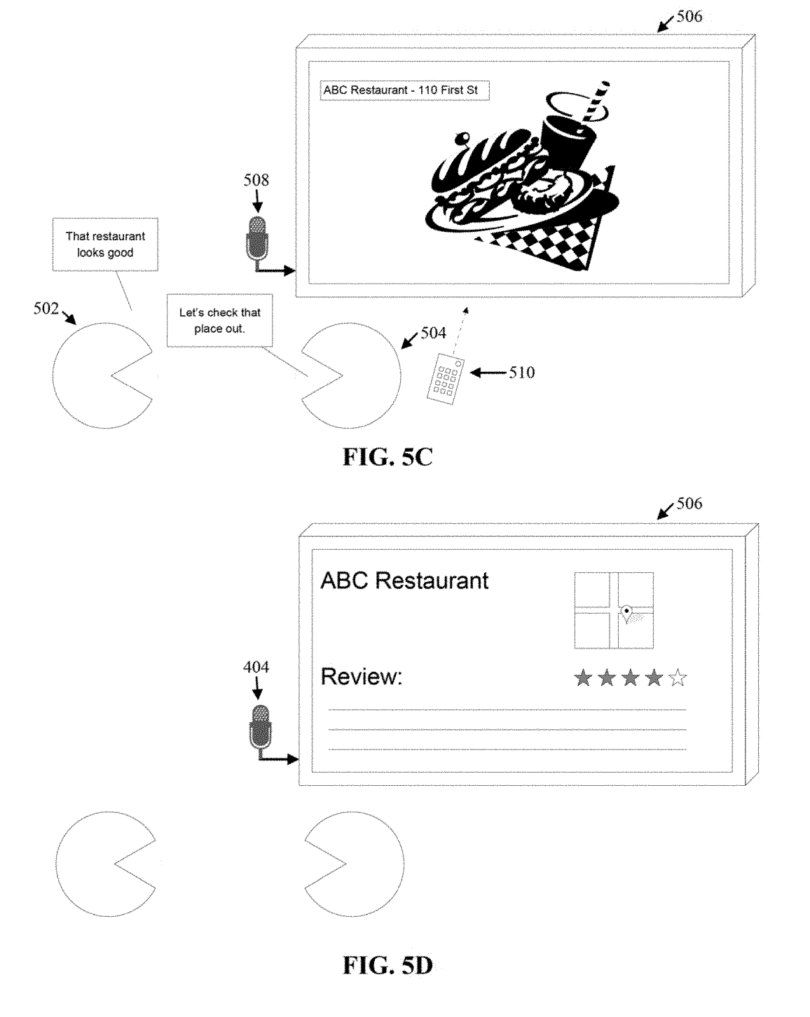

FIGS. 5A to 5F show an illustrative example of content being displayed to two users based on a topic of conversation among the users determined by the topic determination application. FIG. 5A shows an example of two users 502 and 504 having a conversation while a content display application causes content to be displayed on a display 506. A microphone 508 can capture audio from the conversation between user 502 and user 504 and convert that audio as described in connection with FIG. 1. In some implementations, microphone 508 can be a digital microphone that converts audio into a digital audio data, which can then be transmitted to a computing device. Alternatively, microphone 508 can be an analog microphone that transmits an analog signal representing audio captured by microphone 508 to a computing device which can then convert the analog audio data into a digital audio data.

In some implementations, content displayed by the content display application can be a default slideshow if there is no relevant topic of conversation that has been determined. For example, if users 502 and 504 enter a room where display 506 is located and launch the content display application, a slideshow of images can be displayed. In one particular example, a series of beautiful images can be caused to be displayed to a user.

In the example of FIG. 5A, while the content display application is displaying content (such as an image of Hawaii) users 502 and 504 are having a conversation. For example, user 504 says, “Did you see the touchdown pass in the game last night?” The audio from this conversation can be captured by microphone 508 and transmitted to a computing device executing the topic determination application.

As described above in connection with FIG. 1, the topic determination application can convert the audio data to text and match the text to keywords. These matching keywords can be used to generate points associated with one or more general topics of conversation. In the example of FIG. 5A, the words “touchdown,” “pass,” and “game” can all be keywords associated with the topic Sports. Therefore, in this case, the topic determination application can generate points associated with the Sports topic. If user 502 and 504 continue to talk about sports, the topic determination application can continue to generate points associated with the Sports topic. As the score for the Sports topic increases, the topic determination application can select Sports as being a topic that is relevant to the conversation between users 502 and 504.

In some implementations, the content display application can receive a relevant topic (e.g., Sports) from the topic determination application and begin to alter the content that is caused to be displayed based on the relevant topic of conversation. For example, as shown in FIG. 5B, the content display application can cause more content related to sports to be displayed on display 506. As described above, in some implementations, the topic determination application can determine a general topic of conversation without storing information on the content of the conversation. In the example of FIG. 5B, this can result in the content display application displaying content related to the topic of conversation that is not based directly on the content of the conversation. In FIGS. 5A and 5B, the topic determination application determines that users 502 and 504 are talking about sports, as described above in connection with FIG. 5A, and can select information indicating that Sports is the topic of conversation. The content display application can use the information on the topic of conversation to present content related to the topic of conversation. In the case of FIG. 5B, the content display application is displaying an image related to basketball.

If the topic of conversation changes, the topic determination application can change a topic (or topics) accordingly. As described above in connection with FIG. 2, points generated by the topic determination application can expire after a predetermined period of time. This can contribute to the results select by the topic determination application being relevant to the conversation as the conversation changes over time. For example, as new points pertaining to current topics are generated and old points that may not be relevant to current topics anymore expire.

Referring back to the example shown in FIG. 5B, users 502 and 504 may begin talking about a different topic, such as what to eat for lunch. In such an example, the topic determination application can generate points and select a topic of conversation as described in connection with FIG. 1. Accordingly, as users 502 and 504 stop talking about sports and start talking about food, the topic determination application can select Food as the current topic having a highest score. It should be noted that, as described above, multiple topics can be select by the topic determination application, where the topics can be ranked and/or a score associated with the topic can be select in association with each selected topic. In this case, as the users talk more about food, the score for the topic Food increases and, as a result the content display application can cause more material related to food to be displayed to the users.

FIG. 5C shows an example where the content display application causes content related to food to be displayed on display 506 in response to a selection by the topic determination application indicating that the current topic of conversation is Food. In some implementations, as described above, the content presented by the content display application can be local content that is related to the location of the user. In the current example, images from local restaurants can be shown as part of the slideshow when the topic of conversation has been determined to be Food. If the user wants more information about content currently being displayed, the user can show interest in the currently displayed content.

In some implementations, the user can use a remote control device 510 to transmit a signal to the content display application indicating that the user is interested in more information about the currently displayed content. For example, as shown in FIG. 5C, user 504 can use remote control 510 to transmit a signal indicating that he would like more information about the currently displayed content. In response to the user indicating that he would like more information about the currently displayed content additional information about the currently displayed content can be caused to be displayed. In the example of FIG. 5D, the content display application can display a review for the restaurant that is the source of the content displayed in FIG. 5C. Additionally or alternatively, the content display application can display a map indicating a location of the restaurant. It should be noted that a user can indicate interest in any suitable manner such as, by speaking a particular phrase, performing a particular motion, etc.

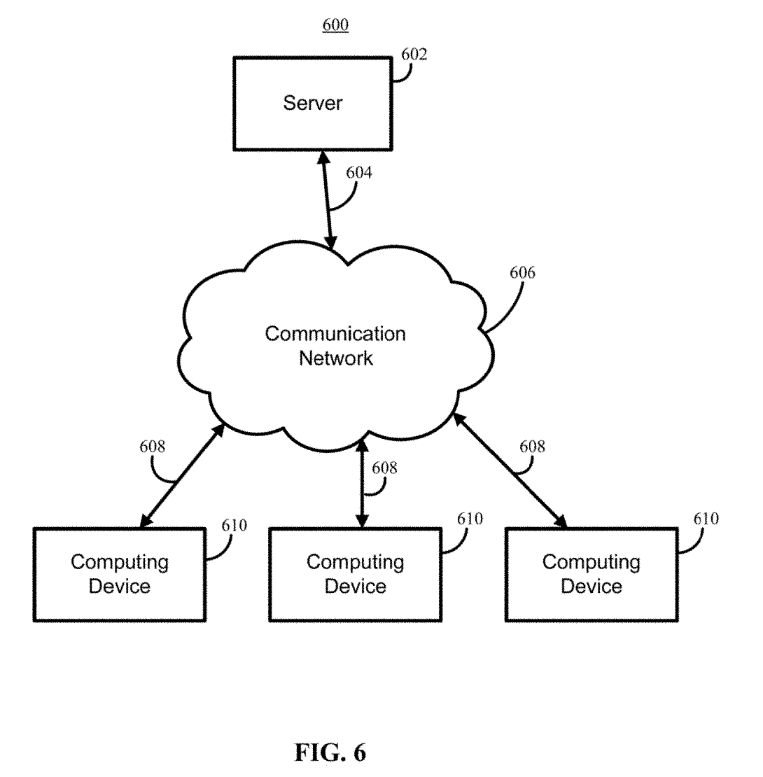

FIG. 6 shows an example 600 of a generalized schematic diagram of a system on which the mechanisms for determining a topic of conversation as described herein can be implemented as a topic determination application in accordance with some implementations. As illustrated, system 600 can include one or more computing devices 610. Computing devices 610 can be local to each other or remote from each other. Computing devices 610 can be connected by one or more communications links 608 to a communications network 606 that can be linked via a communications link 604 to a server 602.

System 600 can include one or more servers 602. Server 602 can be any suitable server such as a processor, a computer, a data processing device, or any suitable combination of such devices for: generating keywords, converting audio data to text data, generating topic scores, retrieving content, retrieving additional information related to the content, etc., and any other suitable functions for executing the topic determination application and/or the content display application. For example, the topic determination application and/or the content display application can be distributed into multiple backend components and multiple frontend components or interfaces. In a more particular example, backend components, such as data collection and data distribution can be performed on one or more servers 602.

It should be noted that, in some implementations, the topic determination application can be implemented on a second screen device, such as a mobile device or a tablet computing device, where content corresponding to a selected topic can be presented on the second screen device. In this implementation, the audio data can be received from an audio input device connected to a media playback device, such as a television device, while content corresponding to a selected topic can be presented on a second screen device, such as a mobile device or a tablet computing device.

In some implementations, each of the computing devices 610 and server 602 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, computing device 610 can be implemented as a set-top box, a smart television, a digital-media receiver, a home entertainment system, a personal computer, a laptop computer, a multimedia terminal, a smartphone, a tablet computer, a personal data assistant (PDA), a game console, etc.

Communications network 606 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), etc. Communications links 604 and 608 can be any communications links suitable for communicating data among computing devices 610 and server 602, such as network links, dial-up links, wireless links, hard-wired links, any other suitable communications links, or any suitable combination of such links. Computing devices 610 can enable use of the techniques described herein that can allow the features of the mechanisms to be used. Computing devices 610 and server 602 can be located at any suitable location.

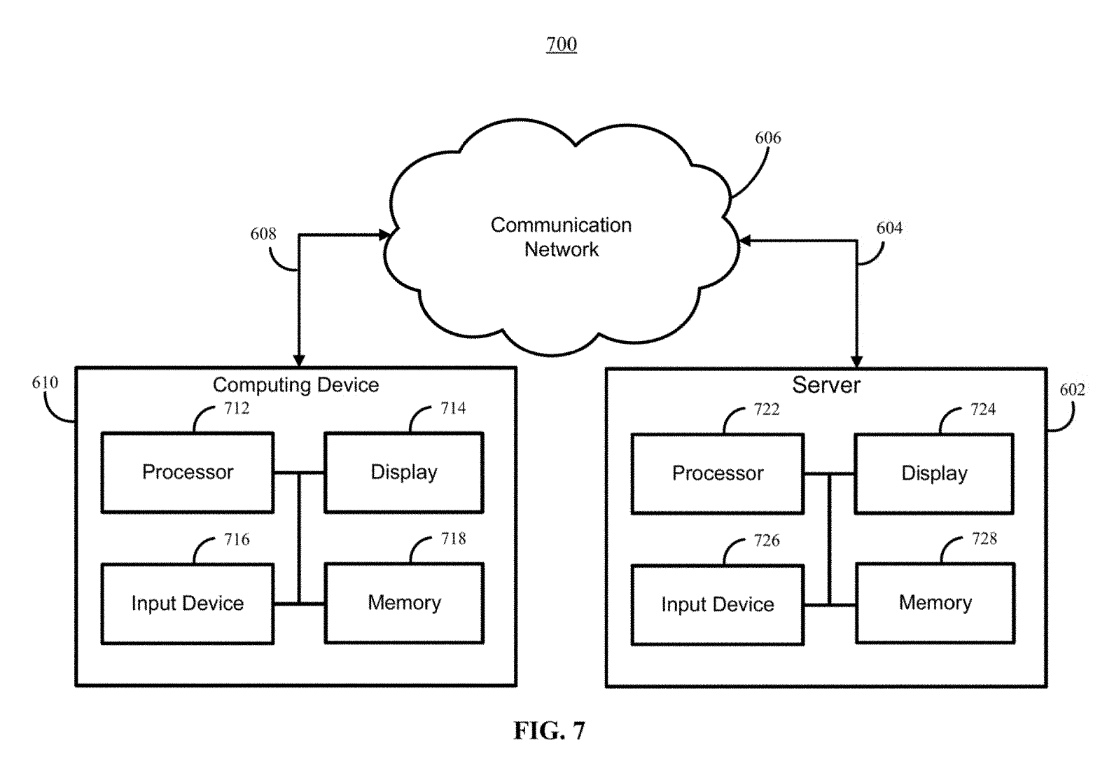

FIG. 7 illustrates an example 700 of hardware that can be used to implement server 602 and one of computing devices 610 depicted in FIG. 6 in accordance with some implementations. Referring to FIG. 7, computing device 610 can include a hardware processor 712, a display 714, an input device 716, and memory 718, which can be interconnected. In some implementations, memory 718 can include a storage device (such as a computer-readable medium) for storing a computer program for controlling hardware processor 712.

Hardware processor 712 can use the computer program to present on display 714 content and/or an interface that allows a user to interact with the mechanisms described herein for determining a topic of conversation and to send and receive data through communications link 608. It should also be noted that data received through communications link 608 or any other communications links can be received from any suitable source. In some implementations, hardware processor 712 can send and receive data through communications link 608 or any other communication links using, for example, a transmitter, receiver, transmitter/receiver, transceiver, or any other suitable communication device. Input device 716 can be a microphone (such as microphone 508), a camera, a remote control, a computer keyboard, a cursor-controller, dial, switchbank, lever, touchscreen, or any other suitable input device.

Server 602 can include a hardware processor 722, a display 724, an input device 726, and memory 728, which can be interconnected. In some implementations, memory 728 can include a storage device for storing data received through communications link 604 or through other links, and can also receive commands and values transmitted by one or more users. The storage device can further include a server program for controlling hardware processor 722.

The mechanisms described herein for determining a topic of conversation and/or for displaying content to a user can be implemented in computing devices 610 as software, firmware, hardware, or any suitable combination thereof.

In some implementations, server 602 can be implemented in one server or can be distributed as any suitable number of servers. For example, multiple servers 602 can be implemented in various locations to increase reliability and/or increase the speed at which the server can communicate with computing devices 610.

In one particular implementation, the content display application can include client-side software, hardware, or both. For example, the application can encompass a computer program written in a programming language recognizable by the content display device executing the application (e.g., a program written in a programming language, such as, Java, C, Objective-C, C++, C#, Javascript, Visual Basic, ColdFusion, or any other suitable approaches).

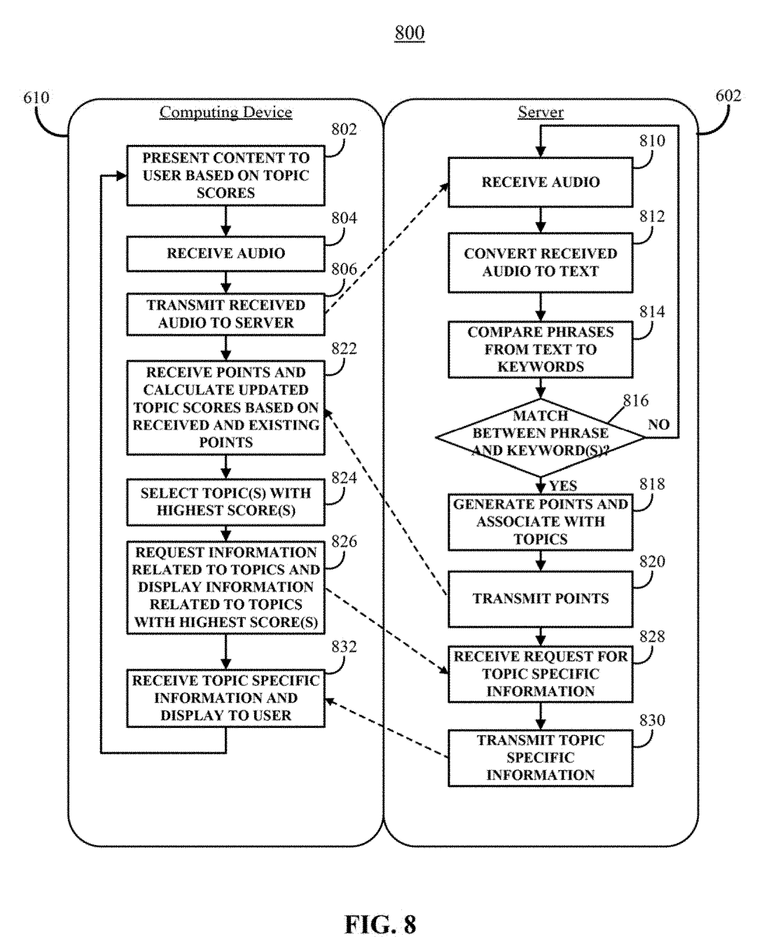

In some implementations, computing device 610 executing the topic determination application and content display application can communicate with server 602 to convert audio to text, compare text to keywords, generate points, display content to a user, etc., using server 602 as shown in example 800 of FIG. 8. At 802, computing device 610 can present content to a user(s) based on topic scores. This can be done using any suitable techniques, such as the techniques described above in connection with FIGS. 1-5. For example, default content can be displayed to a user(s) if there are no topic scores over a threshold (e.g., zero points, ten points, etc.).

At 804, computing device 610 can receive audio data from a location (e.g., a room) or from multiple locations (e.g., a telephone call, video call, video conference, etc.). As described above in connection with, for example, FIGS. 1, 5 and 7, a microphone can be used to capture audio data and transmit the audio data to computing device 610. The audio data received at 804 can be digital audio data or analog audio data that can be converted to digital data by computing device 610.

At 806, the audio data received at 804 can be transmitted to server 602 for conversion to text and comparison of the text to keywords. Transmitting the audio data to a server for processing can allow for lower processing and/or power requirements for computing device 610.

At 810, server 602 can receive the audio data from the computing device and can convert the audio to text at 812, as described above in connection with FIG. 1. In some implementations, server 602 can temporarily store received audio and text converted from received audio in a circular buffer (e.g., implemented in volatile memory, such as memory 728) that will be overwritten when new audio is received and/or when audio is converted to new text. This can insure that the audio captured at the location of the user is not kept.

At 814, server 602 can compare words and/or phrases from the text to keywords associated with topics and at 816 determine if there is a match between a phrase(s) from the text and a keyword. In some implementations, this can be performed using any suitable technique, such as the techniques described above in connection with FIG. 1. For example, words and/or phrases from the text can be compared to a database of keywords to determine if a word or phrase from the text matches any keywords in the database. If it is determined that there is not a match (“NO” at 816), server 602 can return to 810 and continue to receive audio from computing device 610. Otherwise, if it is determined that there is a match (“YES” at 816), server 602 can move to 818 and generate points associated with topics at 818 as described above in connection with FIG. 1. At 820, the point(s) generated by the server at 818 can be transmitted to computing device 610.

At 822, computing device 610 can receive the point(s) generated at 818 and calculate updated topic scores based on the received points and/or existing points, as described above in connection with FIGS. 1 and 2. For example, computing device 610 can maintain a database of points and associated topics, and use this database to calculate updated topic scores for various topics based on whether the audio received at 804 matched keywords at 816.

At 824, computing device 610 can produce a selection of topics having the highest score(s) and/or a ranked list of topics. For example, as described above in connection with FIG. 1, computing device 610, executing the topic determination application, can create a selection of the topic(s) most relevant to a conversation being captured by computing device 610. At 826, computing device 610 can request information from server 602 related to a certain topic(s) based on the topic(s) with highest scores selected at 824. While waiting to receive topic specific information, computing device 610, executing the content display application, can display any information stored in memory 718 of computing device 610 that is related to the topic of conversation (as determined from the topic(s) selected at 824).

At 828, server 602 can receive the request for topic specific information sent from computing device 610. Server 602 can then retrieve topic specific information at 830 using any suitable techniques. For example, server 602 can perform a search for top results for images and/or news regarding specific topics for which information was requested by computing device 610. As another example, server 602 can retrieve content specific information from a database of content specific information that is updated automatically, manually updated, or any suitable combination thereof. Additionally, in some implementations, the topic specific information retrieved can be customized based on the location of the computing device requesting the information. The location of the computing device can be determined by, for example, the IP address of the computing device.

At 832, the topic specific information (e.g., images, news, reviews, etc.) can be transmitted to computing device 610 by server 602.

At 834, computing device 610 can receive the topic specific information from server 602 and can begin incorporating the topic specific information and displaying the topic specific information to a user or users, and return to 804 to continue to receive audio.

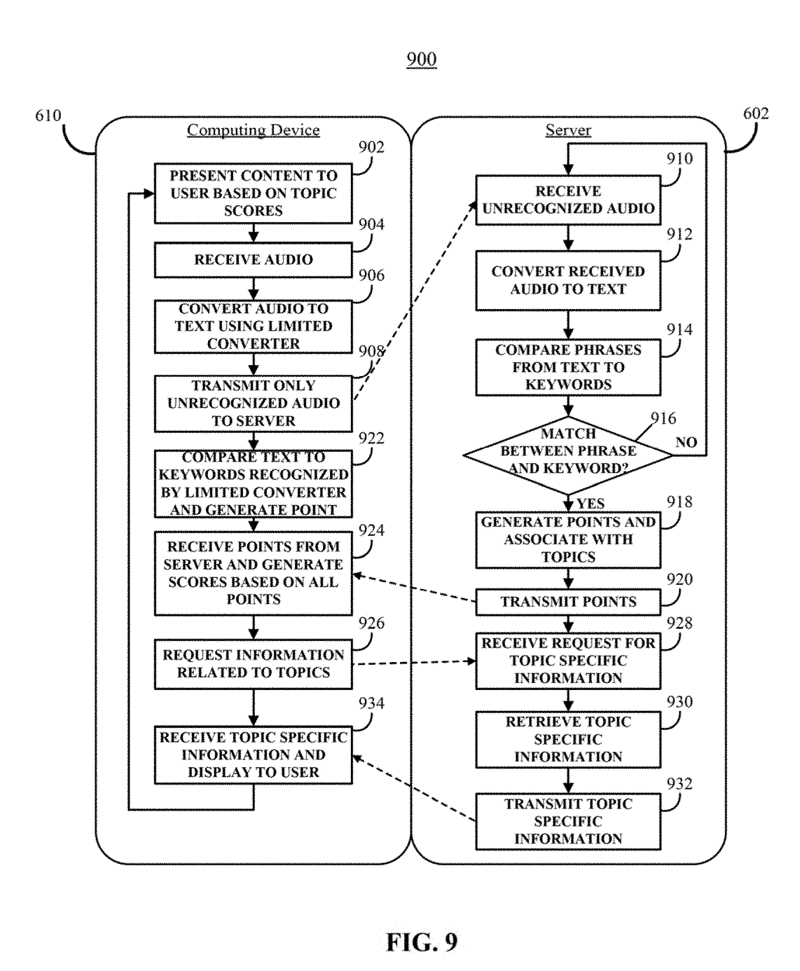

In some implementations, computing device 610 executing the topic determination application and content display application can convert audio to text using a limited audio to text converter and can communicate with server 602 to convert audio that is unrecognized by the limited converter using server 602 as shown in example 900 of FIG. 9. At 902, computing device 610 can present content to a user(s) based on topic scores. This can be done using any suitable techniques, such as the techniques described above in connection with FIGS. 1-5. For example, default content can be displayed to a user(s) if there are no topic scores over a threshold (e.g., zero points, ten points, etc.).

At 904, computing device 610 can receive audio from a location (e.g., a room) or from multiple locations (e.g., a telephone call, video call, video conference, etc.). As described above in connection with, for example, FIGS. 1, 5 and 7, a microphone can be used to capture audio data and transmit the audio data to computing device 610. The audio data received at 904 can be digital audio data or analog audio data that can be converted to digital data by computing device 610.

At 906, computing device 610 can convert the audio data received at 904 to text using a limited audio to text converter. For example, a Hidden Markov Model trained to recognize only a limited set of words and/or phrases can be used. Such a limited converter can be trained to recognize common words that relate to the topics associated with the topic determination application and common words used in the language that is being converted into text. For example, common parts of speech such as “the,” “I,” etc. can be recognized by the limited recognizer.

At 908, computing device 610 can transmit sections of audio that were not recognized by the limited converter to server 602. This can further increase privacy protections by transmitting audio that corresponds to select words rather than all audio received by computing device 602.

At 910, server 602 can receive the audio data corresponding to unrecognized sections of the audio received by computing device 610 at 902. Server 602 can convert the sections of audio to text at 912 using a full converter (e.g., a converter trained to recognize a larger set of words than the limited converter used at 906). For example, server 602 can convert the audio sections transmitted from computing device 610 using techniques described above in connection with FIG. 1. In some implementations, server 602 can temporarily store received audio and text converted from received audio in a circular buffer (e.g., implemented in volatile memory, such as memory 728) that will be overwritten when new audio is received and/or when audio is converted to new text. This can insure that the audio captured at the location of the user is not kept. Additionally, the full converter used by server 602 at 912 can exclude words that are recognized by the limited converter.

At 914, server 602 can compare words and/or phrases from the text to keywords associated with topics and at 916 to determine if there is a match between a phrase(s) from the text and a keyword. In some implementations, this can be performed using any suitable technique, such as the techniques described above in connection with FIG. 1. For example, words and/or phrases from the text can be compared to a database of keywords to determine if a word or phrase from the text matches any keyword(s) in the database. If it is determined that there is not a match (“NO” at 916), server 602 can return to 910 and continue to receive audio from computing device 610. Otherwise, if it is determined that there is a match (“YES” at 916), server 602 can move to 918 and generate points associated with topics as described above in connection with FIG. 1. At 920, the point(s) generated by the server at 918 can be transmitted to computing device 610.

At 922, computing device 610 can compare words and/or phrases from the text converted by the limited converter to keywords recognized by the limited converter. Computing device 610 can also generate points corresponding to matching keywords and move to 924. Comparing, matching and generating points can be carried out, for example, as described in connection with FIG. 1.

At 924, computing device 610 can receive points generated at server 602 and can generate scores for each topic, as described above in connection with FIGS. 1 and 2, based on the points received from server 602 and the points generated by computing device 610 at 922. For example, computing device 610 can maintain a database of points and associated topics, and use this database to calculate updated topic scores for various topics based on whether the audio received at 904 matched keywords at 922 and/or 916.

At 926, computing device 610 can request information from server 602 related to certain topics based on the topics with highest scores selected at 924. While waiting to receive topic specific information, computing device 610, executing the content display application, can display any information stored in memory 718 of computing device 610 that is related to the topic of the conversation (as determined from the topic(s) selected at 924).

At 928, server 602 can receive the request for topic specific information sent from computing device 610. Server 602 can then retrieve topic specific information at 930 using any suitable techniques. For example, server 602 can perform a search for top results for images and/or news regarding specific topics for which information was requested by computing device 610. As another example, server 602 can retrieve content specific information from a database of content specific information that is updated automatically, manually updated, or any suitable combination thereof. Additionally, in some implementations, the topic specific information retrieved can be customized based on the location of the computing device requesting the information. The location of the computing device can be represented by, for example, the IP address of the computing device.

In some implementations, when server 602 receives a request for topic specific information, it can record topic information and generalized location information (or any other suitable information) of computing device 610 that requested the topic specific information. This information can be used to generate infographics, graphs, charts, statistics, etc., based on the recorded information.

At 932, the topic specific information (e.g., images, news, reviews, etc.) can be transmitted to computing device 610 by server 602.

At 934, computing device 610 can receive the topic specific information from server 602 and can begin incorporating the topic specific information and displaying the topic specific information to a user or users, and return to 804 to continue to receive audio.

In some implementations, a full or limited audio to text converter can be used by a computing device 610 with no audio or text data being transmitted to a server. This can increase the privacy protection offered by the mechanisms described herein by performing all conversion and matching in computing device 610.

In accordance with various implementations, mechanisms for providing content based on a level of conversation and shared interests during a social event are provided. In some implementations, the mechanisms for providing content based on a level of conversation can determine that a social event is in progress and identify the attendees of the social event. The mechanisms for providing content based on a level of conversation can, in some implementations, determine a level of conversation based on audio data and/or video data captured of the social event. In some implementations, the mechanisms for providing content based on a level of conversation can retrieve information on the identified users' interests (e.g., from a social networking service) and use common interests or unique information of the users as the basis for presenting content to initiate or facilitate a conversation. For example, if the level of conversation is below a threshold level of conversation, the mechanisms for providing content based on a level of conversation can cause information about common interests of two or more of the users to be presented to the users at the social event to provide a basis for starting a conversation. Additionally, in some implementations, if the level of conversation is above the threshold level of conversation, the mechanisms for providing content based on a level of conversation can cause content to be presented based on a topic of conversation (e.g., as described above in connection with FIGS. 1-9).

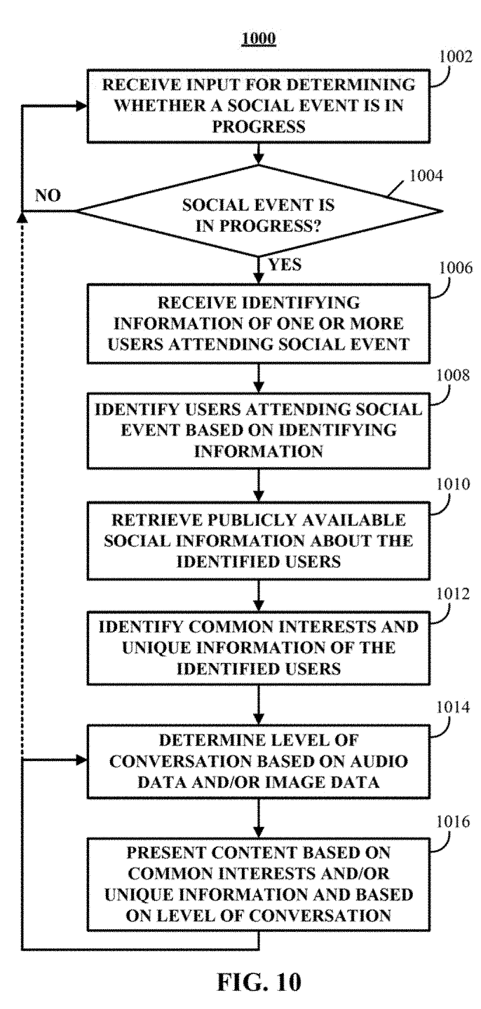

FIG. 10 shows an example 1000 of a process for presenting content based on a level of conversation and shared interests during a social event in accordance with some implementations of the disclosed subject matter. As shown in FIG. 10, process 1000 can begin, at 1002, by receiving input for determining whether a social event is in progress. Process 1000 can use any suitable input and/or technique or combination of techniques to determine whether a social event is in progress. For example, process 1000 can determine that a social event is in progress based on a number of people in a vicinity of a system for executing and/or utilizing process 1000. For example, if a system for executing process 1000 is in a room of a dwelling such as a home, an apartment, a dormitory, etc., process 1000 can determine whether a social event is in progress based on the number of people in the room and/or nearby rooms. Process 1000 can use any suitable technique or combination of techniques to determine the number of people, such as capturing images of the room or rooms and using image processing techniques to determine the number of people. Additionally or alternatively, process 1000 can use sensors that count the number of people based on the number of people entering and/or leaving a particular entrance, determining the number and/or identity of mobile devices associated with different people (e.g., smartphones, tablet computers, wearable computers, etc.), and/or using any other suitable techniques. In some implementations, the social event can include users that are remotely connected (e.g., via an audio and/or video feed). In such implementations, information that such users are attendees of the event can be gathered from a computing device being used to connect the user remotely, and/or based on any other suitable information.

As another example, process 1000 can determine that a social event is in progress based on an input from a user. This input can, for example, be a command from a remote control or smartphone to a device executing process 1000, indicating that a social event is in progress. Additionally or alternatively, the input can be a voice command indicating that a social event is in progress.

As yet another example, process 1000 can determine that a social event is in progress based on a user's calendar information. In such an example, process 1000 can receive information from a user's calendar indicating that the user is holding and/or attending a social event at a location that coincides with the location of a device executing process 1000.

As still another example, process 1000 can determine that a social event is in progress based on information associated with one or more users that is made publicly available by one or more social networking services. In such an example, process 1000 can use the users' locations and/or social connections to determine a number of people at a location associated with a device executing process 1000. Additionally or alternatively, process 1000 can use information that is available to direct social connections of a particular user (e.g., a user that is logged in to a device executing process 1000) and/or information available to that user. In some implementations, publicly available information can include any suitable information visible to attendees of the social event. For example, publicly available information can include information in a publicly visible profile on a social networking service that is visible to the public at large (e.g., any user of the social network). As another example, publicly available information can include information visible to users at the social event (e.g., due to social connections between the attendees at the social event). As yet another example, publicly available information can include information that is visible to the public at large from another source (e.g., from a blog, a micro-blog, etc.) that is available to the public. As still another example, publicly available information can include information designated by a user as public information to be used by the mechanisms described herein (and/or any other suitable mechanisms). In a more particular example, the user can select certain information from an existing social network profile to make visible to the mechanisms described herein (and/or any other suitable mechanisms). As another more particular example, the user can indicate one or more sources of information that are to be used to determine the user's interests (e.g., a particular social network profile(s), an account on another service for sharing information, a blog or micro-blog, and/or any other suitable source of information). In some implementations, such user selected information or sources of information can be used to determine broad interests (e.g., indicating that the user is a basketball fan, likes coffee, and likes watching reality television shows), or more specific interests (e.g., indicating that the user is a fan of a particular basketball team, indicating that the user prefers a certain brand of coffee, and that the user watches a particular reality televisions show). In some implementations, the user can control a level of abstraction of the user's determined interests by manually inputting those interests as broadly or narrowly as desired, and/or by specifying a level of abstraction for those interests. In some implementations, the mechanisms described herein can determine a user's broad interests from more specific information, for example, by using techniques similar to those discussed above for determining a topic of conversation in connection with FIG. 1.

At 1004, process 1000 can determine whether a social event is in progress. In some implementations, as described above in connection with 1002, process 1000 can use any suitable information and/or techniques to determine whether a social event is in progress. For example, process 1000 can determine that a social event is in progress based on the number of people present being over a threshold number of people (e.g., three people, five people, etc.). As another example, process 1000 can determine that a social event is in progress if an input indicating that a social event is in progress has been received (e.g., a device executing process 1000 is put into a “party” mode by a user). As still another example, process 1000 can determine that a social event is in progress based on information from one or more social networking services, indicating that a threshold number of people (e.g., three people, five people, etc.) are all attending a social event and/or that the number of direct connections between the people is below a threshold (e.g., less than 50% of the people are directly connected to multiple others in the group).

If process 1000 determines that a social event is not in progress (“NO” at 1004), process 1000 can return to 1002 and continue to receive input for determining whether a social event is in progress. Otherwise, if process 1000 determines that a social event is in progress (“YES” at 1004), process 1000 can proceed to 1006.

At 1006, process 1000 can receive identifying information of one or more users attending the social event. Such identifying information can include any suitable information that can be used to identify the users. For example, process 1000 can receive image data of the users' faces captured by one or more cameras associated with a system executing process 1000. Process 1000 can then use this image data to identify the users by utilizing one or more facial recognition techniques to match the image data of each user's face to a known user having known facial characteristics. In some implementations, each user identified using facial recognition can be required to consent to process 1000 accessing that user's information, such as personal information. This consent can be communicated, for example, using gestures and/or sound generated by the user.

As another example, process 1000 can cause a request to be presented (e.g., using a display and/or one or more speakers associated with a device executing process 1000) that each user allow access to that user's identifying information. Such a request can include, for example, an event code or other information for identifying the event and instructions to allow access to the user's identifying information. The event code can be, for example, alphanumeric, can be encoded into a graphic (e.g., as a QR code), and/or can be presented as an auditory signal (which can be audible and/or inaudible to a human). In some implementations, the request can include a URL or other address where the code can be entered. In a more particular implementation, a user can be instructed to scan a QR code presented by process 1000 using the user's smartphone and a particular application. Scanning the QR code can cause the smartphone (or other suitable device) to navigate to a particular address where the user is prompted to permit process 1000 to access the user's identifying information on one or more services (e.g., social networking services).

As yet another example, process 1000 can receive identifying information from one or more user devices associated with users attending the social event. Process 1000 can use any suitable technique or combination of techniques to receive the identifying information. In a more particular example, process 1000 can receive the identifying information from a mobile device (e.g., a smartphone, a tablet, a wearable computer, etc.) associated with the user as a response to a request submitted to the mobile device for such identifying information. In some implementations, such a request can initiate a process on the mobile device to supply such information to process 1000 as a response to the request. Additionally, in some implementations, the mobile device can query a user prior to sending such a response to request permission from the user to send the response. In another more particular example, process 1000 can cause such a response to be sent using any suitable techniques, such as using a short range wireless protocol (e.g., such as the wireless protocol developed by the BLUETOOTH, the WIRELESS USB wireless communication protocol, etc.), over a local area network to which both the mobile device and a device executing process 1000 are connected (e.g., by a wireless connection such as a Wi-Fi connection, by a wired connection such as an Ethernet connection, and/or using any other suitable connections). Additionally, in some implementations, process 1000 can use any suitable device discovery protocol for determining whether any devices associated with users are present (e.g., in the vicinity of a device executing process 1000, on the same network as the device executing process 1000, etc.). Such device discovery protocols can include, for example, Simple Service Discovery Protocol (SSDP), discovery protocols associated with the BLUETOOTH wireless protocol, and/or any other suitable device discovery protocols. Any suitable identifying information can be received from the mobile device, such as the user's real name, a URL associated with the user (e.g., a URL of a social networking profile associated with the user), the user's email address, the user's username on a social networking site, the user's phone number, identifying information of the device (e.g., a serial number, a MAC address, and/or any other device identifying information), and/or any other suitable information for identifying the user. Additionally or alternatively, process 1000 can receive information related to the user's interests from the user's mobile device in lieu of or in addition to receiving such information as described below in connection with 1010 and 1012.

At 1008, process 1000 can identify one or more users attending the social event based on the received identifying information. For example, process 1000 can use the received image data to identify the users attending the social event. As another example, once granted access to the information (e.g., by the user granting access using a smartphone), process 1000 can identify one or more addresses of information about the user. In some implementations, identifying the users attending the social event can include identifying sources of publicly available information about that user, such as publicly available information provided by a social networking service. For example, process 1000 can identify: one or more social networking service profiles associated with the user; one or more micro-blogs associated with the user; one or more blogs; information from one or more user accounts for consuming media content such as video, text, audio, etc.; information from one or more online marketplaces; and/or any other suitable source of information about the user. In some implementations, process 1000 can verify the identity of the users attending the social event. For example, upon identifying a particular user (e.g., using facial recognition techniques), process 1000 can cause the identity of the user to be presented for confirmation by the user. Process 1000 can then, for example, receive an indication of whether the user has been accurately identified. In some implementations, if a user indicates that the identification is not accurate, process 1000 can reinitiate identification, can query that user to determine a proper identification, can proceed without identifying that user, and/or can take any other suitable action. In some implementations, process 1000 can identify the one or more users based on identifying information received in a response from the user's mobile device (e.g., as described above in connection with 1006). For example, process 1000 can receive identifying information from the mobile device, and use such information for identifying sources of information about the user.

At 1010, process 1000 can retrieve publicly available social information about the identified users. For example, process 1000 can access information from the one or more sources of information about the user identified at 1008. This information can include, for example, a user's stated interests, a user's implied interests, media content that the user has consumed, media content and/or products about which the user has commented on and/or that the user has rated, and/or any other suitable public information about the user. In some implementations, a user's implied interests can be based on user actions such as what types of media content the user consumes, what types of products the user buys, the user's actions with relation to the content and/or products (e.g., whether the user is engaged with the content/product by commenting and/or “liking” the content/product, a rating given to the content/product, etc.).

At 1012, process 1000 can determine interests that are common to two or more of the users identified at 1008, and/or unique information about a user identified at 1008. In some implementations, process 1000 can determine where a group of users identified at 1008 share common interests. Process 1000 can then use these common interests as the basis for presenting information to the users attending the social event in order to provide a topic of conversation, for example, as described below in connection with 1016. Such common interests can be, for example: a genre of music or a musical artist in which multiple users are interested; a book, movie, television show, etc., that multiple users rated highly and/or consumed; a current event that multiple users have recently commented on, read about, watched a video about, etc.; and/or any other suitable interests. As another example, process 1000 can identify common connections of multiple users, such as a person that multiple users know, a place that multiple users have visited, etc. In some implementations, each user's social connections can be analyzed, and process 1000 can preferentially identify common interests of users that are not directly connected by a social networking service.

Additionally or alternatively, process 1000 can identify unique information about one or more of the users that is related to a topic that interests one or more other users. For example, process 1000 can identify that one user has watched a particular video and engaged with the video (e.g., by “liking” the video, sharing the video using a social network, commenting on the video, etc.) and that other users have not watched the video (e.g., any number of other users, such as a majority of users, all other users, etc.). As another example, process 1000 can identify a place that a user has visited and/or a place that a user is from to which other users have not been. In some implementations, process 1000 can preferentially identify unique information about one or more users related to a topic of topics in which other users are interested. For example, process 1000 can identify a place that a first user has visited that other users have not visited preferentially if the other users are interested in travel.

At 1014, process 1000 can determine a level of conversation among attendees of the social event. Process 1000 can determine the level of conversation based on any suitable data. For example, in some implementations, process 1000 can receive audio data from one or more microphones. Process 1000 can use this audio data to determine a level of conversation, which can be based on, for example, how many different attendees are speaking (e.g., a proportion of attendees participating in conversation), a topic or topics being discussed (e.g., which can be determined using techniques described above in connection with FIGS. 1-9), a frequency and/or velocity of conversation (e.g., how often different users speak, a proportion of time users spend talking, lengths and/or numbers of pauses in conversation, etc.), and/or any other suitable information indicative of a level of conversation.

As another example, process 1000 can receive image data from one or more cameras. Process 1000 can use this image data to determine a level of conversation, which can be based on, for example, facial expressions of users in the images, movement of the users between images or groups of images (e.g., hand gestures, how closely users are standing to one another, whether users are mingling or standing in one place, etc.). In some implementations, the image data can be from video data captured by one or more cameras positioned to capture an area or areas where the identified users are congregating.

At 1016, process 1000 can cause content to be presented based on the common interests of users and/or unique information and/or based on a level of conversation. In some implementations, any suitable technique or combination of techniques can be used to determine which content is to be presented. In some implementations, the common interests and/or unique information can be used as the basis of all information that is to be presented during a social event. Alternatively, the common interests and/or unique information can be used as the basis of at least a portion of information that is to be presented during the social event. In some implementations, the common interests and/or unique information identified at 1012 can be used as the basis of inputs for a process, such as process 100 described above in connection with FIG. 1, for presenting content based on a particular topic. In such implementations, the common interests and/or unique information can be used as a current topic of conversation by, for example, process 100, which can then cause content to be presented that is associated with that topic.

In some implementations, process 1000 can cause the amount of content suggestions that are to be presented to be increased when the level of conversation is relatively low. Additionally or alternatively, process 1000 can cause the amount of content suggestions that are to be presented to be decreased when the level of conversation is relatively high. In some implementations, process 1000 can cause content that is to be presented when the level of conversation is relatively high to be content related to a current topic of conversation in addition to, or in lieu of, content based on common interests and/or unique information.

In some implementations, process 1000 can cause more engaging content to be presented when the level of conversation is relatively low. Such more engaging content can include, for example, a video that one user has watched and enjoyed, and that other users have not watched (e.g., unique information about the user that watched the video).

In some implementations, process 1000 can cause the content presented at 1016 to be presented using any suitable technique of combination of techniques. For example, words based on the content to be presented can be presented as a word cloud with more common items presented larger in comparison to less common items. As another example, images can be presented that represent the content to be presented such as an image representing a book that multiple users are interested in, an image representing a genre of music that multiple users are interested in, etc. As yet another example, one or more videos can be presented that represent the content to be presented. As still another example, audio can be presented that represents the content to be presented. In some implementations, a combination of different types of content can be presented concurrently to represent common interests and/or unique information about a user.

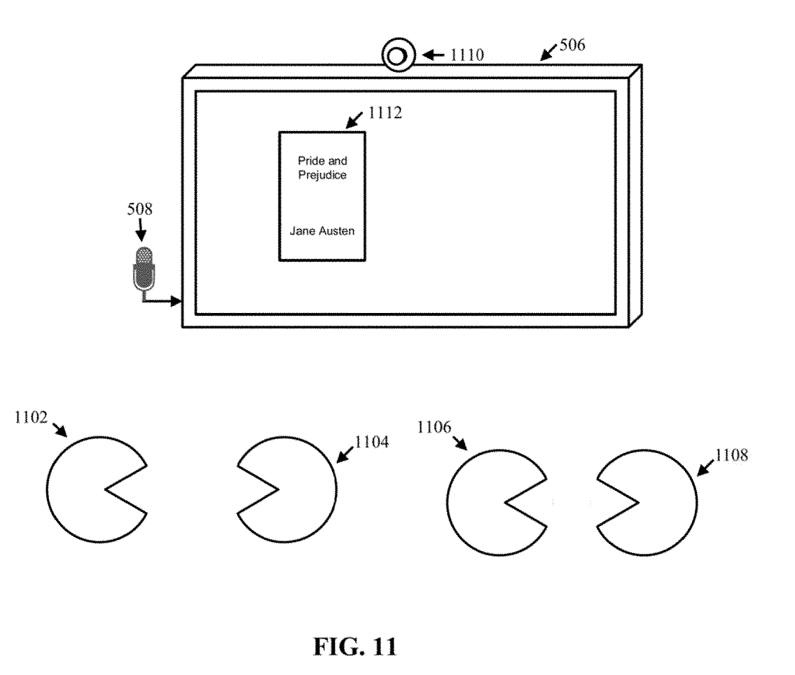

FIG. 11 shows an example of a group of four users 1102-1108 attending a social gathering while the mechanisms described herein cause content to be presented by display 506 in accordance with some implementations of the disclosed subject matter. Camera 1110 can capture image data of when users, such as users 1102-1108 enter and leave a field of view of camera 1110 and/or can capture images of the users' faces to be used to identify the users. In some implementations, multiple cameras 1110 can be positioned to capture different fields of view. In some implementations, microphone 508 can capture audio from the conversation between users 1102-1108 and convert that audio as described in connection with FIG. 1. Process 1000 can use this audio data, for example, to determine a level of conversation as described above in connection with 1014 of FIG. 10 and/or process 100 can use the audio data to determine a topic of conversation.

As shown in FIG. 11, in some implementations, content 1112 can be presented using display 506. Content 1112 can represent, for example, a book that one or more of users 1102-1108 has read and enjoyed (e.g., a common interest). Presentation of content 1112 can, for example, provide a starting point for conversation among two or more of users 1102-1108 (e.g., among users that have read the book, users that may be interested in the book, etc.).

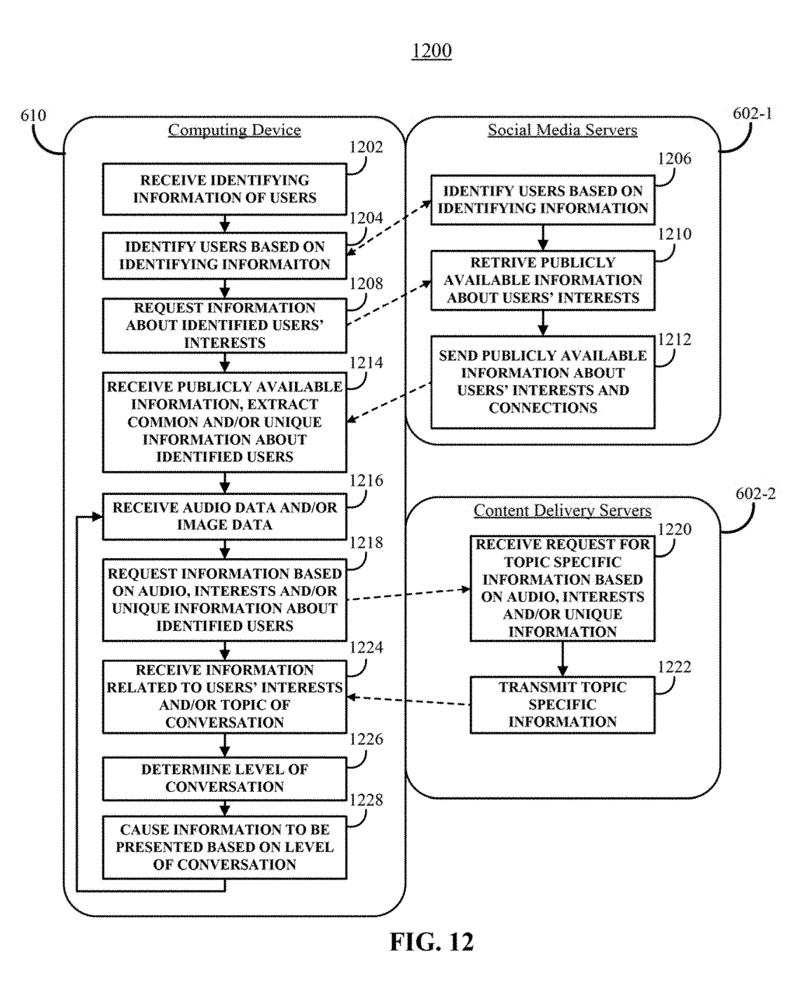

FIG. 12 shows a diagram illustrating an example 1200 of a data flow that can be used in processes of FIG. 10 among a computing device 610, one or more social media servers 602-1, and one or more content delivery servers 602-2 in accordance with some implementations of the disclosed subject matter. At 1202, computing device 610 can receive identifying information of one or more users attending a social event (e.g., as described above in connection with 1006 of FIG. 10). At 1204, computing device 610 can communicate with, for example, social media servers 602-1 to identify the users for whom identifying information was received at 1202.

At 1206, social media servers 602-1 can identify one or more users based on the identifying information, and may or may not share the information on the identity of the one or more users with computing device 610. For example, as discussed above in connection with 1006 and/or 1008 of FIG. 10, social media servers 602-1 can use facial recognition techniques on image data including a face of a user to identify the user (e.g., by matching the face in the image data with known facial features of the user), and/or using any other suitable techniques for identifying a user. In some implementations, computing device 610 can communicate with social media servers 602-1 separately for each potential user, such that social media servers 602-1 cannot determine that all of the users are connected.

At 1208, computing device 610 can request information about identified users' interests. In some implementations, such a request may or may not include which users the information is being requested in connection with. For example, the identity of the users may not be communicated from social media servers 602-1 back to computing device 610, such that computing device 610 does not receive user identity information for the users. In some implementations, the request for users' interests can be included at 1204 when identifying the users in conjunction with social media servers 602-1.

At 1210, social media servers 602-1 can retrieve publicly available information about the identified users' interests. For example, in some implementations, such information can include any suitable information as described above in connection with 1010 of FIG. 10.

At 1212, social media servers 602-1 can send the publicly available information about the user's interests and/or social connections to computing device 610. In some implementations, such information can be treated such that personal information of the user is obscured. For example, each user can be assigned an identification number or code name and the personal information and social connections of each user can be relayed to computing device 610 using such an identification number or code name.

At 1214, computing device 610 can receive the publicly available information and/or social connections from social media servers 602-1. Additionally, in some implementations, computing device 610 can extract common and/or unique information about the identified users, for example, as described above in connection with 1012 of FIG. 10.

At 1216, computing device 610 can receive audio data and/or image data from microphone 508 and/or camera 1110. Such audio data and/or image data can be received using any suitable techniques and/or at any suitable time. For example, such data can be received substantially continuously, every second, every minute, etc. In some implementations, audio data can be received substantially continuously, while image data can be gathered less frequently, or vice versa.

At 1218, computing device 610 can request information from content delivery servers 602-2 based on the audio data and/or video data (e.g., as described above in connection with FIGS. 1-9). Such information can, for example, be based on a current topic of conversation. Additionally or alternatively, in some implementations, computing device 610 can request information based on the common interests and/or unique information extracted at 1214. Such requested information can be, for example, information that computing device 610 (and/or any other suitable computing device executing any suitable processes) identifies as information related to a topic that will facilitate conversation among the identified users.

At 1220, content delivery servers 602-2 can receive the request for topic specific information that is based on the audio received at 1216, interests of the identified user and/or unique information of the identified users. Such a request can take any suitable form and can be received using any suitable technique or combination of techniques. For example, the request can be a search query using the topic of conversation (e.g., determined based on the audio data), the interests of the identified users (e.g., based on topics of interest or specific items of interest), and/or the unique information about an identified user as the basis for the search query. As another example, the request can be a request for a particular content item, such as a content item included in the interests or unique information about the identified users. In some implementations, content delivery servers 602-2 can include multiple content delivery servers for delivering different types of content and/or content from different sources.

At 1222, content delivery servers 602-2 can transmit topic specific information to computing device 610 using any suitable technique or combination of techniques.

At 1224, computing device 610 can receive the topic specific information related to the identified users' interests, unique information and/or a topic of conversation using any suitable techniques. Such received information can be, for example, stored in memory 718, and/or treated using any suitable techniques to prepare such information for presentation (e.g., using display 506).

At 1226, computing device 610 can determine a level of conversation based on the audio data and/or image data (as well as any other suitable data received from any suitable source). For example, computing device 610 can determine the level of conversation as described above in connection with 1014 of FIG. 10.

At 1228, computing device can cause information to be presented (e.g., using display 506) based on the level of conversation. For example, information related to the users' interests and/or the topic of conversation can be presented as described above in connection with 1016). After presenting such information based on the level of conversation, computing device 610 can return to 1216 and can continue to receive audio data and/or image data. In some implementations, computing device 610 can make a determination of the level of conversation substantially continuously or periodically (e.g., once per minute, once every five minutes, etc.). In some implementations, the information to be presented can be arranged, formatted, and/or controlled by computing device 610 (e.g., computing device 610 can use the information received at 1224 to create content to be presented at 1228). Additionally or alternatively, content delivery servers 602-2 can arrange, format and/or control the content to be presented at 1228. For example, the content can be composed using content delivery servers 602-2 and streamed to computing device 610 (and/or display 506) for presentation.

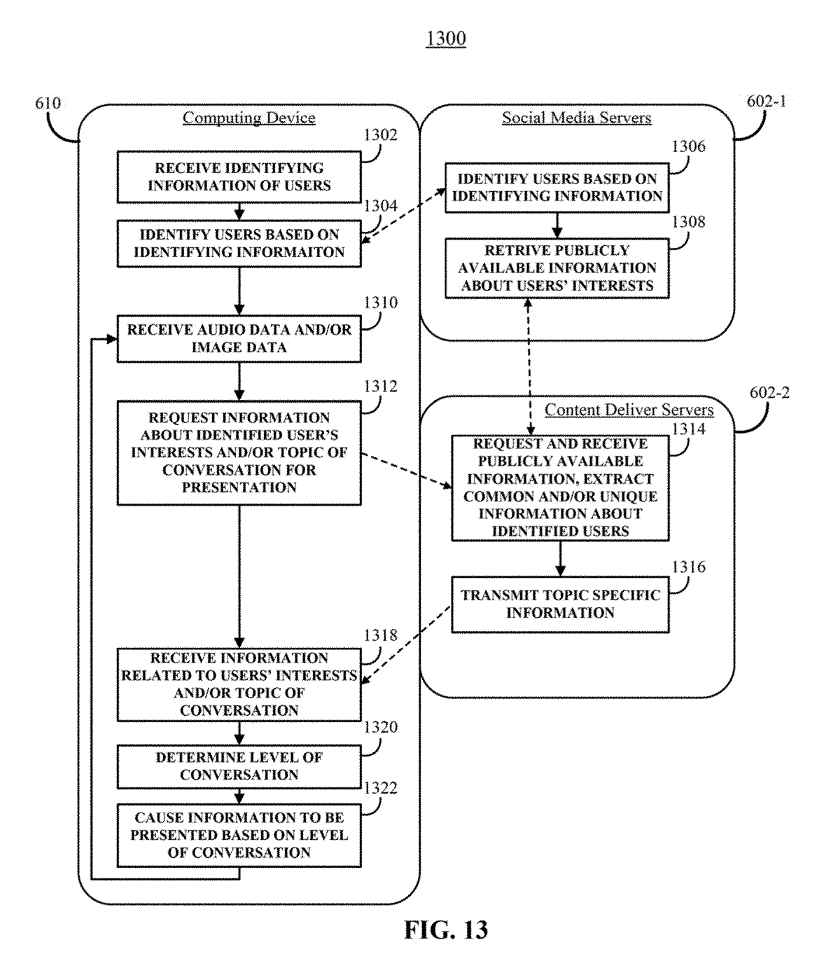

FIG. 13 shows a diagram illustrating another example 1300 of a data flow that can be used in processes of FIG. 10 among computing device 610, social media servers 602-1, and content delivery servers 602-2 in accordance with some implementations of the disclosed subject matter. At 1302, computing device 610 can receive identifying information of one or more users (e.g., as described above in connection with 1202 of FIG. 12). At 1304, computing device 610 can communicate with, for example, social media servers 602-1 to identify the users for whom identifying information was received at 1302.

At 1306, social media servers 602-1 can identify the users based on the identifying information (e.g., as described above in connection with 1206 of FIG. 12). At 1308, social media servers 602-1 can retrieve publicly available information about the users identified at 1306 (e.g., as described above in connection with 1208 of FIG. 12). In some implementations, unlike what is described above in connection with FIG. 12, social media server 602-1 can send the publicly available information retrieved at 1308 to content delivery servers 602-2, for example, with instructions to make such content available to computing device 610.

At 1310, computing device 610 can receive audio data and/or image data as described above in connection with 1216 of FIG. 12. At 1312, computing device 610 can request information about identified users' interests for and/or a topic of conversation for presentation (e.g., using display 506), as described above in connection with 1218.

At 1314, content delivery servers 602-2 can receive the request for information from computing device 610. In some implementations, content delivery servers 602-2 can retrieve the requested information based on information about the identified users' interests sent from social media servers 602-1 in association with identifying information of computing device 610 (e.g., if content delivery servers 602-2 already received such information). Additionally or alternatively, content delivery servers 602-2 can request information about identified users' interests from social media servers 602-1 based on identifying information received from computing device 610 (and/or based on identifying information of computing device 610, which is recognized by social media servers 602-1 as being associated with the identified users). As described above in connection with 1220 of FIG. 12, content delivery servers can receive the request in any suitable form and can identify any suitable information.

At 1316, content delivery servers 602-2 can transmit topic specification information about a topic of conversation and/or the identified users' interests as described above in connection with 1222 of FIG. 12.

At 1318, computing device 610 can receive the information related to the identified users' interests and/or the topic of conversation using any suitable technique or combination of techniques, for example, as described above in connection with 1224.

At 1320, computing device 610 can determine a level of conversation using any suitable technique or combination of techniques, for example, as described above in connection with 1226 of FIG. 12.

At 1322, computing device 610 can cause information to be presented based on the level of conversation determined at 1320, for example, as described above in connection with 1228 of FIG. 12.

It should be noted that in implementations described herein in which the mechanisms for providing information based on the level of conversation and shared interests (or other mechanisms described herein) collect information about a particular user, the user will be provided with an opportunity to control whether the topic determination application (or other mechanisms) collects information about particular users and/or how collected user information is used by the topic determination application (or other mechanisms). Examples of information about a user can include an image of the user, the user's interests, the user's location, names spoken by the user, etc. Additionally, certain information about the user can be stored locally (e.g., not shared), encrypted, and/or treated in one or more ways before it is stored to remove personal information. For example, a user's identity can be treated such that no personal information can be determined for the user. As another example, a user's geographic location can be generalized where location information is obtained (e.g., to a city level, a ZIP code level, a state level, etc.), so that a particular location of a user cannot be determined. Using these techniques and others described herein, the user can have control over what information is collected about the user and/or how that information is used by the topic determination application (or other mechanisms).

In some implementations, any suitable computer readable media can be used for storing instructions for performing the functions and/or processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that the above described steps of the processes of FIGS. 1, 2, 5, 8-10, 12 and 13 can be executed or performed in any order or sequence not limited to the order and sequence shown and described in the figures. Also, some of the above steps of the processes of FIGS. 1, 2, 5, 8-10, 12 and 13 can be executed or performed substantially simultaneously where appropriate or in parallel to reduce latency and processing times.

It should also be noted that, as used herein, the term mechanism can encompass hardware, software, firmware, or any suitable combination thereof.

Accordingly, methods, systems, and media for providing content based on a level of conversation and shared interests during a social event are provided.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

1. A method for providing content based on shared interests, the method comprising:
receiving, using a hardware processor, image data from a camera device associated with the hardware processor, wherein the camera device is positioned to capture the image data corresponding to a particular room;
determining, using the hardware processor, a number of users that are located in the particular room using image recognition techniques on the received image data, wherein the particular room is a physical room that includes a display device;
determining, using the hardware processor, that a live social event is in progress based on the determined number of users that are located in the particular room;
causing, using the hardware processor, the display device to present instructions for the users that are located in the particular room to authorize access to social networking profiles associated with each user via a user device utilizing information presented on the display device in connection with the instructions;
in response to receiving a first authorization that is based on the information presented on the display device, from a first user device, to access a first social networking profile associated with a first user, causing, using the hardware processor, information about one or more interests of the first user to be retrieved from the first social networking profile;
in response to receiving a second authorization that is based on the information presented on the display device, from a second user device, to access a second social networking profile associated with a second user, causing, using the hardware processor, information about one or more interests of the second user to be retrieved from the second social networking profile;
extracting, using the hardware processor, interests common to the first user and the second user from the retrieved information about the one or more interests of the first user and the one or more interests of the second user; and
causing, using the hardware processor, the display device to present content based on the extracted common interests during the live social event.

2. The method of claim 1, wherein the number of users is determined based at least in part on image data of the users that are located in the particular room captured during the live social event.

3. The method of claim 1, wherein determining the number of users comprises identifying a user device associated with each of one or more of the users that are located in the particular room.

4. (canceled)

5. The method of claim 1, further comprising:
receiving audio data captured during the live social event;
determining a level of conversation based on the audio data; and
wherein causing content to be presented based on the extracted common interests comprises determining an amount of content to presented based on the level of conversation.

6. The method of claim 5, wherein the amount of content to be presented is increased upon determining that the level of conversation is below a threshold.

7. A system for providing content based on shared interests, the system comprising:
a hardware processor programmed to:
receive image data from a camera device associated with the hardware processor, wherein the camera device is positioned to capture the image data corresponding to a particular room;
determine a number of users that are located in the particular room using image recognition techniques on the received image data, wherein the particular room is a physical room that includes a display device;
determine that a live social event is in progress based on the determined number of users that are located in the particular room;
cause the display device to present instructions for the users that are located in the particular room to authorize access to social networking profiles associated with each user via a user device utilizing information presented on the display device in connection with the instructions;
in response to receiving a first authorization that is based on the information presented on the display device, from a first user device, to access a first social networking profile associated with a first user, cause information about one or more interests of the first user to be retrieved from the first social networking profile;
in response to receiving a second authorization that is based on the information presented on the display device, from a second user device, to access a second social networking profile associated with a second user, cause information about one or more interests of the second user to be retrieved from the second social networking profile;
extract interests common to the first user and the second user from the retrieved information about the one or more interests of the first user and the one or more interests of the second user; and
cause the display device to present content based on the extracted common interests during the live social event.

8. The system of claim 7, wherein the number of users is determined based at least in part on image data of the users that are located in the particular room captured during the live social event.

9. The system of claim 7, wherein determining the number of users comprises identifying a user device associated with each of one or more of the users that are located in the particular room.

10. (canceled)

11. The system of claim 7, wherein the hardware processor is further programmed to:
receive audio data captured during the live social event;
determine a level of conversation based on the audio data; and
wherein causing content to be presented based on the extracted common interests comprises determining an amount of content to presented based on the level of conversation.

12. The system of claim 11, wherein the amount of content to be presented is increased upon determining that the level of conversation is below a threshold.

13. A non-transitory computer-readable medium containing computer executable instructions that, when executed by a processor, cause the processor to perform a method for providing content based on shared interests, the method comprising:
receiving image data from a camera device associated with the hardware processor, wherein the camera device is positioned to capture the image data corresponding to a particular room;
determining a number of users that are located in the particular room using image recognition techniques on the received image data, wherein the particular room is a physical room that includes a display device;
determining a number of users that are located in a particular room, wherein the particular room is a physical room that includes a display device;
determining that a live social event is in progress based on the determined number of users that are located in the particular room;
causing the display device to present instructions for the users that are located in the particular room to authorize access to social networking profiles associated with each user via a user device utilizing information presented on the display device in connection with the instructions;
in response to receiving a first authorization that is based on the information presented on the display device, from a first user device, to access a first social networking profile associated with a first user, causing information about one or more interests of the first user to be retrieved from the first social networking profile;
in response to receiving a second authorization that is based on the information presented on the display device, from a second user device, to access a second social networking profile associated with a second user, causing information about one or more interests of the second user to be retrieved from the second social networking profile;
extracting interests common to the first user and the second user from the retrieved information about the one or more interests of the first user and the one or more interests of the second user; and
causing the display device to present content based on the extracted common interests during the live social event.

14. The non-transitory computer-readable medium of claim 13, wherein the number of users is determined based at least in part on image data of the users that are located in the particular room captured during the live social event.

15. The non-transitory computer-readable medium of claim 13, wherein determining the number of users comprises identifying a user device associated with each of one or more of the users that are located in the particular room.

16. (canceled)

17. The non-transitory computer-readable medium of claim 13, wherein the method further comprises:
receiving audio data captured during the live social event;
determining a level of conversation based on the audio data; and
wherein causing content to be presented based on the extracted common interests comprises determining an amount of content to presented based on the level of conversation.

18. The non-transitory computer-readable medium of claim 17, wherein the amount of content to be presented is increased upon determining that the level of conversation is below a threshold.
